(19) United States
(12) Patent Application Publication
(10) Pub. No.: US 2007/0107293 A1
(43) Pub. Date: May 17, 2007

(54) Apparatus and method for imparting mechanical vibration to fish bait

(75) Inventor: Michael Carl Hendricks, Brevard, NC (US)

Correspondence Address: DAVID M. CARTER;CARTER SCHNEDLER & MONTEITH, P.A., 56 CENTRAL AVENUE, SUITE 101, P.O. BOX 2985, ASHVILLE, NC, 28802, US

(73) Assignee: Three Ridges, LLC, Brevard, NC (US)

(21) Appl. No.: 11/595,369

(22) Filed: Nov. 8, 2006

Related U.S. Application Data
(60) Provisional application No. 60/737,736, filed on Nov. 16, 2005.

(51) Int. Cl. A01K 91/06

(52) U.S. Cl. 43/19.2; 43/25

(57) ABSTRACT

There is provided a fishing apparatus and a method for fishing. A fishing rod having a proximal end and a distal end are provided. A fishing line contacts a portion of the distal end of the fishing rod. Fish bait is connected to the free end of the fishing line. A mechanism is provided for imparting a vibration to the fishing rod so that the fishing line and the fish bait may be caused to vibrate.

### RELATIONSHIP TO PRIOR APPLICATION

This is a U.S. non-provisional application relating to and claiming the benefit of U.S. Provisional Patent Application Ser. No. 60/737,736, filed Nov. 16, 2005.

### BACKGROUND OF THE INVENTION

This invention relates to an apparatus and method for fishing. More particularly, it relates to an apparatus and method for imparting vibration to fish bait.

As used herein, the term “fish bait” broadly means live bait such as live worms and minnows, other organic bait such as dough balls, and artificial lures. It is known that fish are attracted to fish bait when the bait is jiggled, i.e., vibrated. Normally, this jiggling or vibration is accomplished by the fisherman rapidly moving the fishing pole in short jerky motions. Certain artificial lures have been designed to vibrate rapidly in the water when being retrieved so as to provide a sound in the water to attract fish.

### SUMMARY OF THE INVENTION

In accordance with one form of this invention, there is provided a fishing apparatus including a fishing rod having a proximal end and a distal end. The apparatus further includes a fishing line contacting a portion of the distal end of the fishing rod. The fishing line has a free end and fish bait is connected to the free end. A mechanism is provided for imparting a vibration to the fishing rod so that the fishing line and the fish bait may be caused to vibrate.

In accordance with another form of this invention, there is provided a method for fishing using a fishing rod, fish line and fish bait wherein the fish bait is attached to one end of the fishing line and the rod contacts a portion of the line. The method comprises casting the fish bait into a fishable body of water; reducing slack which may be in the fishing line between the rod and the fish bait; and applying a vibration to the rod, the vibration being transferred to the fishing line and to the bait.

In accordance with yet another form of this invention, there is provided a device for providing a vibration to a fishing rod. The device includes a stiff resilient wire. The wire includes a clamp portion for securing the device to the fishing rod. The wire includes an actuation portion for enabling the user of the fishing rod to apply vibration to the rod using the device.

### BRIEF DESCRIPTION OF THE DRAWINGS

The subject matter which is regarded as the invention is set forth in the appended claims. The invention itself, however, together with further objects and advantages thereof may be better understood in reference to the accompanying drawings in which:

FIG. 1 is a pictorial view of an apparatus forming one embodiment of the invention attached to a fishing rod.

FIG. 2 is a perspective view of the vibration imparting device shown in FIG. 1.

FIG. 3 is a more detailed perspective view showing the apparatus of FIG. 1 and a portion of the fishing rod.

FIG. 4 is a perspective view of the apparatus and fishing rod of FIG. 3, but shown from a different angle.

FIG. 5 is a partial perspective view showing an alternative embodiment of the invention.

FIG. 6 is a pictorial view illustrating the apparatus and method of the subject invention.

### DESCRIPTION OF THE PREFERRED EMBODIMENTS OF THE INVENTION

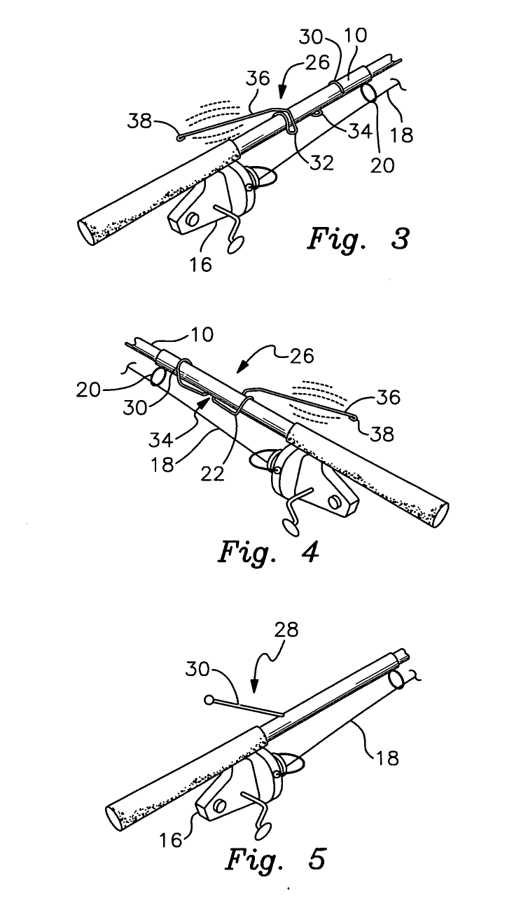

Referring now more particularly to the embodiments of FIGS. 1-4 and FIG. 6, there is provided fishing rod 10 having proximal end 12 and distal end 14. Fishing reel 16 is attached to rod 10 near proximal end 12. By “proximal end,” it is meant the end of the rod which is held by the fisherman. By “distal end,” it is meant the tip of the rod or the end of the rod which is furthest away from the fisherman. Fishing line 18 is payed out from fishing reel 16 through a plurality of eyelets 20 which are attached to fishing rod 10. Fish bait 22 is attached to free end 24 of fishing line 18. Fishing line 18 is in contact with distal end 14 of fishing rod 10 since it passes through eyelet 20A which is attached to distal end 14 of rod 10. Vibration device 26 is attached to rod 10 near proximal end 12 and adjacent to fishing reel 16.

In the embodiment of FIG. 5, the vibration device 28 in the form of resilient finger 30 extending from rod 10 is made integral with rod 10.

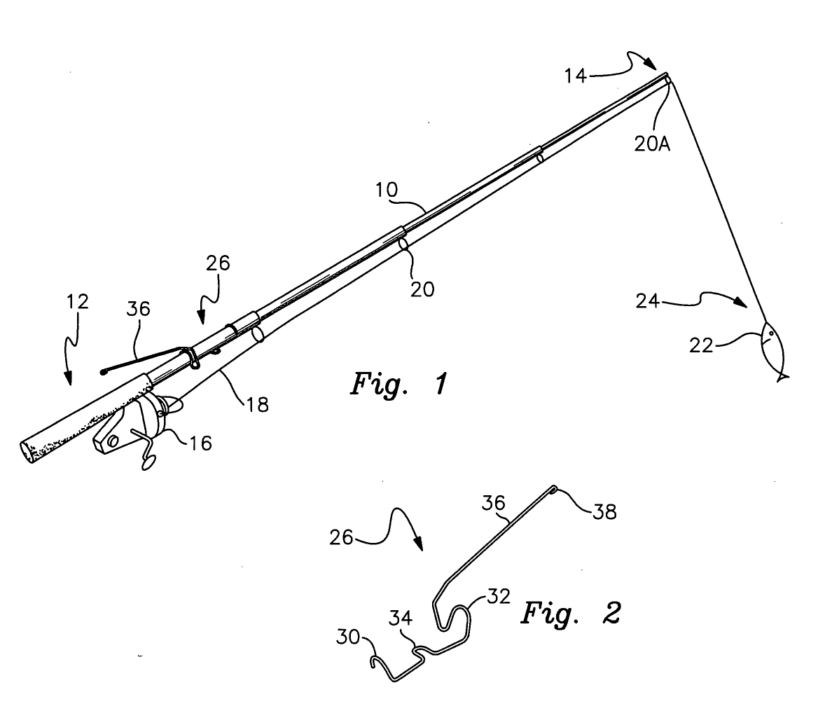

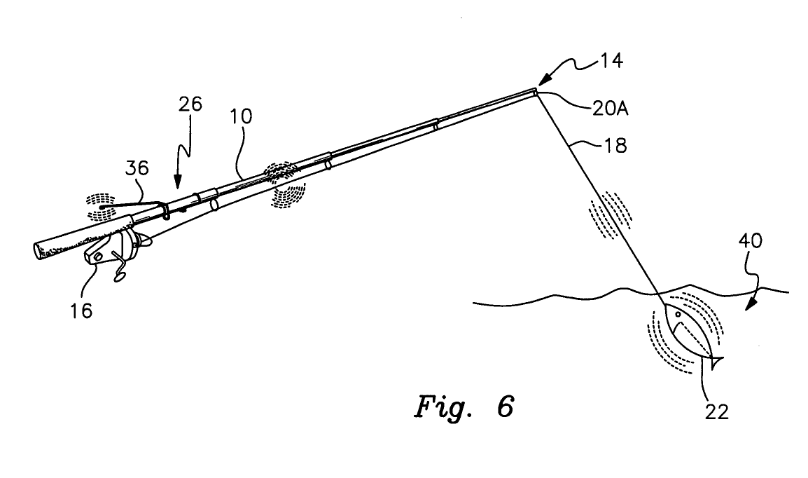

In the preferred embodiment as shown in FIG. 2, vibration device 26 is in the form of a resilient wire which is formed into a shape so as to enable one to conveniently clip or clamp device 26 onto rod 10. Device 26 includes first loop 30 and second loop 32, each of which are adapted to clip to one side of rod 10. Device 26 includes third loop 34 which is adapted to make contact with the other side of rod 10 to further secure device 26 to rod 10. The axis of third loop 34 is perpendicular to the axes of the first and second loops. Device 26 further includes actuation member 36 which is a spring. When device 26 is attached to rod 10 as shown in FIG. 1, actuation member 36 extends away from rod 10 towards the fisherman (not shown). The placement of device 26 near proximal end 12 of rod 10 with the actuation member extending away from the rod and towards the fisherman enables the fisherman to stroke actuation member 36 at or near its free end 38, which has been looped so as to prevent injury to one's thumb, and enables one to impart vibration to rod 10, to line 18, and thus to fish bait 22, all of which is best illustrated in reference to FIG. 6.

Although it is believed that any vibration of fish bait 22 will attract fish, it is preferred that the vibrations be in a frequency range so as to be detectable by a fish without the fish having to see the vibrating bait 22. It is believed that fish have a lateral line or some type of sensor on the fish body which picks up vibrations in the water. It is believed that a frequency in the range of approximately 55 cycles per second to approximately 120 cycles per second would be most effective, although the invention is not limited to that specific vibration frequency range.

The device and apparatus of the subject invention may be used in accordance with the method of the subject invention as set forth below.

The fisherman casts bait 22 into fishable waters 40. Reel 16 is cranked so as to take the slack out of line 18. The fisherman then strums vibration actuation member 36 with his thumb causing fishing rod 10 to vibrate. The vibration of fishing rod 10 causes taut fishing line 18 to also vibrate because of the fishing line's contact with eyelet 20A on the distal end 14 of fishing rod 10. The vibration of line 18 causes fish bait 22 to also vibrate. It has been found that the vibrating bait 22 will often attract fish. It is also believed that the vibrating fishing line 18 also attracts fish.

The fisherman may also strum actuation member 36 while he or she is retrieving bait 22 by cranking fish reel 16. The fisherman can control the timing, modulation and rhythm of the vibration by tightening line 18 and strumming actuation member 36.

This invention does not interfere with the casting or retrieval of the fish bait. The device shown in FIG. 2 will also fit most commercially available spinning rods.

From the foregoing description of the preferred embodiments of the invention, it will be apparent that many modifications may be made therein. It should be understood, however, that each of these embodiments of the invention are exemplifications of the invention only and that the invention is not limited thereto. It is to be understood, therefore, that it is intended in the appended claims to cover all modifications as fall within the true spirit and scope of the invention.

1. A fishing apparatus comprising:
a fishing rod having a proximal end and a distal end;
fishing line; said fishing line contacting a portion of said distal end of said fishing rod; said fishing line having a free end;
fish bait; said fish bait connected to said free end of said fishing line; and
a mechanism for imparting a vibration to said fishing rod whereby said fishing line and said fish bait may be caused to vibrate.

2. An apparatus as set forth in claim 1 wherein said mechanism is attached to said rod.

3. An apparatus as set forth in claim 1 wherein said mechanism is integral with said rod.

4. An apparatus as set forth in claim 2 wherein said mechanism is attached to said rod near said proximal end.

5. An apparatus as set forth in claim 4 wherein said mechanism includes a clamping member for attaching said mechanism to said rod.

6. An apparatus as set forth in claim 1 wherein said mechanism includes an actuation member for generating the vibration.

7. An apparatus as set forth in claim 6 wherein said actuation member is in the form of a spring device extending away from said rod and being positioned so that said actuation member may be conveniently contacted by the user of said rod.

8. An apparatus as set forth in claim 5 wherein said clamping member includes a pair of loops extending about portions of said rod.

9. An apparatus as set forth in claim 2 wherein said mechanism is a continuous piece of stiff resilient wire having first and second loops contacting at least one side of said rod; said wire having a third loop located between said first and second loops contacting the other side of said rod; said wire including an elongated spring member.

10. An apparatus as set forth in claim 9 wherein the axis of said third loop is perpendicular of the axes of said first and second loops.

11. An apparatus as set forth in claim 1 further including a fishing reel; said fishing reel contains a portion of said fishing line; said fishing reel attached near said proximal end of said rod.

12. An apparatus as set forth in claim 11 wherein said fishing rod includes a plurality of eyelets; said fishing line passing through said eyelets.

13. An apparatus as set forth in claim 1 wherein the vibration has a frequency ranging between approximately 55 cycles per second and approximately 120 cycles per second.

14. A method for fishing using a fishing rod, fishing line and fish bait wherein said fish bait is attached to one end of said fishing line and said rod contacts a portion of said line comprising:
casting said bait into a fishable body of water;
reducing slack which may be in said fishing line between said rod and said bait;
applying a vibration to said rod; said vibration being transferred to said fishing line and to said fish bait.

15. A method as set forth in claim 14 wherein the vibration frequency is between approximately 55 cycles per second and approximately 120 cycles per second.

16. A method as set forth in claim 14 wherein said vibration is applied by a mechanism attached to said rod.

17. A method as set forth in claim 14 wherein said vibration is applied by a mechanism integral with said rod.

18. A method as set forth in claim 14 wherein said vibration is applied to said rod by the fisherman strumming an actuation member which extends said rod.

19. A device for applying a vibration to a fishing rod comprising:
a stiff resilient wire; said wire including a clamp portion for securing said device to said fishing rod; said wire including an actuation portion for enabling the user of said fishing rod to apply a vibration to said rod using said device.

20. A device as set forth in claim 19 wherein said actuation portion is in the form of a spring device adapted to be positioned so that said spring device is adapted to extend away from said rod and positioned so that said actuation portion may be conveniently contacted by said user of said rod.

21. A device as set forth in claim 20 wherein said clamp portion includes a pair of loops adapted to be extended about portions of said rod.

22. A device as set forth in claim 19 wherein said wire is stiff and resilient and has and first and second loops and wherein said first and second loops are adapted to contact at least one side of said rod; said wire having a third loop located between said first and second loops; said third loop being adapted to contact the other side of said rod; said actuation portion being an elongated spring member.
